(19) United States
(12) Patent Application Publication
(10) Pub. No.: US 2026/0307725 A1
(43) Pub. Date: Oct. 8, 2026

(54) VEHICLE FRAMEWORK STRUCTURE

(71) Applicant: TOYOTA JIDOSHA KABUSHIKI KAISHA, Toyota-shi (JP)

(72) Inventor: Hiromu KOTAKI, Seto-shi (JP)

(73) Assignee: TOYOTA JIDOSHA KABUSHIKI KAISHA, Toyota-shi (JP)

(21) Appl. No.: 19/537,874

(22) Filed: Feb. 12, 2026

(30) Foreign Application Priority Data
Apr. 4, 2025 (JP) 2025-062813

(51) Int. Cl. B62D 21/17

(52) U.S. Cl. CPC B62D 21/17

(57) ABSTRACT

The vehicle framework member is provided with a first face, a second face, an erect face and a rib. The first face has a fastening portion to which the ground terminal is attached, and the second face is formed having a height that is lower than that of the first face. On the other hand, the rib is connected to the erect face, partially surrounds the second face at the first outer edge portion on the second mounting seat side on the second face, and the abutting piece of the ground terminal abuts against the rib. The second face is a first inclined face inclined toward the vehicle downward side in a direction away from the erect face. Thus, on the second face, the water immersed on the second face is discharged along the first inclined face, it is possible to suppress water from accumulating on the second face.

### CROSS-REFERENCE TO RELATED APPLICATION

This application claims priority to Japanese Patent Application No. 2025-062813 filed on Apr. 4, 2025. The disclosure of the above-identified application, including the specification, drawings, and claims, is incorporated by reference herein in its entirety.

### BACKGROUND

### 1. Technical Field

The present disclosure relates to a vehicle framework structure.

### 2. Description of Related Art

Japanese Unexamined Patent Application Publication No. 2017-130258 (JP 2017-130258 A) discloses technology relating to a waterproofing structure provided in a bolt-fastened portion of a vehicle metal body. In this related art, a waterproofing member is provided so as to surround a bolt hole formed in the vehicle metal body, and when a ground terminal is fastened to the vehicle, this waterproofing member is pressed and a bolt is fastened, thereby realizing waterproofing.

### SUMMARY

However, in the above-described related art, when water accumulates in the vicinity of the ground terminal, the ground terminal may become corroded.

The present disclosure has been made in consideration of the above circumstances, and it is an object thereof to provide a vehicle framework structure that is capable of suppressing accumulation of water in the vicinity of a ground terminal.

A vehicle framework structure according to a first aspect includes a vehicle framework member that is integrally molded by casting,

the vehicle framework member including

a first face including a fastening portion to which a ground terminal is attached,

a second face of which a height is lower than that of the first face,

an erect face connecting the fastening portion and the second face in a height direction, and

a rib connected to the erect face and partially surrounding the second face, the rib being abutted by an abutting piece formed on the ground terminal, in which

the second face is a first inclined face that inclines toward a vehicle downward side in a direction away from the erect face.

The vehicle framework structure according to the first aspect includes the vehicle framework member that is integrally molded by casting, and the vehicle framework member is provided with the first face, the second face, the erect face and the rib. The first face has the fastening portion to which the ground terminal is attached, and the second face is formed such that the height thereof is lower than that of the first face. The fastening portion provided on the first face, and the second face, are connected in the height direction by the erect face.

On the other hand, the rib is connected to the erect face to partially surround the second face, and also a distal end portion of the ground terminal abuts against the rib. Accordingly, when the ground terminal is attached to the fastening portion, the distal end portion of the ground terminal abuts against the rib with respect to a rotation direction of the fastening member, such that the ground terminal is suppressed from rotating.

Here, the second face is the first inclined face that is inclined toward the vehicle downward side in the direction away from the erect face. Therefore, water guided to the second face is guided (discharged) toward the vehicle downward side along the first inclined face. As described above, according to the present aspect, water can be suppressed from accumulating on the second face by providing a drain path through which the water collected on the second face is discharged.

With the vehicle framework structure according to a second aspect,

in the vehicle framework structure according to the first aspect,

the second face is configured including a first outer edge portion connected to the erect face, and on which the rib is erected and

a second outer edge portion that is connected to the erect face and that faces the first outer edge portion, and

the first inclined face further includes a second inclined face inclined toward the vehicle downward side from a second outer edge portion side toward a first outer edge portion side.

With the vehicle framework structure according to the second aspect, in the vehicle framework structure according to the first aspect, the second face is connected to the erect face and is configured including the first outer edge portion and the second outer edge portion facing each other, and the rib is erected on the first outer edge portion side. Here, the first inclined face further includes the second inclined face inclined toward the vehicle downward side from the second outer edge portion side toward the first outer edge portion side.

Thus, in the present aspect, the first inclined face and the second inclined face are formed on the second face, such that the water guided over the second face is guided (discharged) toward the vehicle downward side along the first inclined face and the second inclined face. Accordingly, in the present aspect, water can be further suppressed from accumulating on the second face.

With the vehicle framework structure according to a third aspect, in the vehicle framework structure according to the second aspect, the rib is fashioned on an upstream side in an inclination direction of the first inclined face, and the second inclined face is fashioned on a downstream side in the inclination direction of the first inclined face.

In the vehicle framework structure according to the third aspect, the rib is formed on the upstream side of the first inclined face in the inclination direction, and the second inclined face is formed on the downstream side of the first inclined face in the inclination direction. That is to say, in the present aspect, at the second face, water flows along the inclination of the first inclined face on the side on which the rib is provided, and water flows along the inclination of the second inclined face on the side on which the rib is not provided. Accordingly, in the present aspect, water on the second face can be discharged to another face through the portion where the rib is not provided.

With the vehicle framework structure according to a fourth aspect,

in the vehicle framework structure according to the first aspect,

the ground terminal is configured including

a conductive portion fastened to the fastening portion,

a distal end portion fashioned on a face that is different from the conductive portion and that is configured to abut the rib, and

a linking piece connecting between the conductive portion and the distal end portion in the height direction, and

a height of the erect face is higher than a length of the linking piece.

In the vehicle framework structure according to the fourth aspect, the ground terminal is configured including the conductive portion, the distal end portion, and the linking piece. The conductive portion is fastened to the fastening portion, and the distal end portion is formed on a face different from the conductive portion and can be brought into contact with the rib. The linking piece also connects the conductive portion and the distal end portion in the height direction. In the present aspect, the height of the erect face connecting the first face and the second face is higher than the length of the linking piece.

Accordingly, when the conductive portion of the ground terminal is fastened to the fastening portion, a gap is provided between the distal end portion and the second face in a state in which the distal end portion of the ground terminal is in contact with the rib. Accordingly, even if there is water around the rib, the distal end portion can be suppressed from coming into contact with the water.

As described above, the vehicle framework structure according to the present disclosure can suppress water from accumulating in the vicinity of the ground terminal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle framework member to which a vehicle framework structure according to an embodiment of the present disclosure is applied, viewed from a vehicle right obliquely front side and an upper side;

FIG. 2 is an enlarged perspective view showing a main part of a vehicle framework member to which the vehicle framework structure according to the present embodiment is applied in an enlarged manner;

FIG. 3 is an exploded perspective view showing a configuration of a vehicle framework structure according to the present embodiment;

FIG. 4 is a perspective view for explaining the operation of the vehicle framework structure according to the present embodiment;

FIG. 5A are plan views for explaining the operation of the vehicle framework structure according to the embodiment.

FIG. 5B is a cross-sectional view taken along VB-VB line shown in FIG. 5A; and

FIG. 6 is a rear view illustrating a state in which FIG. 4 is viewed from a vehicle rear side.

### DETAILED DESCRIPTION OF EMBODIMENTS

Hereinafter, a vehicle framework structure according to an embodiment of the present disclosure will be described with reference to the drawings. Note that an arrow FR appropriately shown in the drawings indicates a front side in the vehicle front-rear direction, and an arrow UP indicates an upper side in the vehicle up-down direction. The arrow RH indicates the right side in the vehicle width direction, and in the present embodiment, indicates the outer side in the vehicle width direction. Hereinafter, in the case of simply describing the front-rear direction, the up-down direction, and the left-right direction, unless otherwise specified, the front-rear direction of the vehicle front-rear direction, the up-down direction of the vehicle up-down direction, and the left-right direction of the vehicle (vehicle width direction) are represented.

### Configuration of vehicle framework structure

First, the configuration of the vehicle framework structure according to the present embodiment will be described.

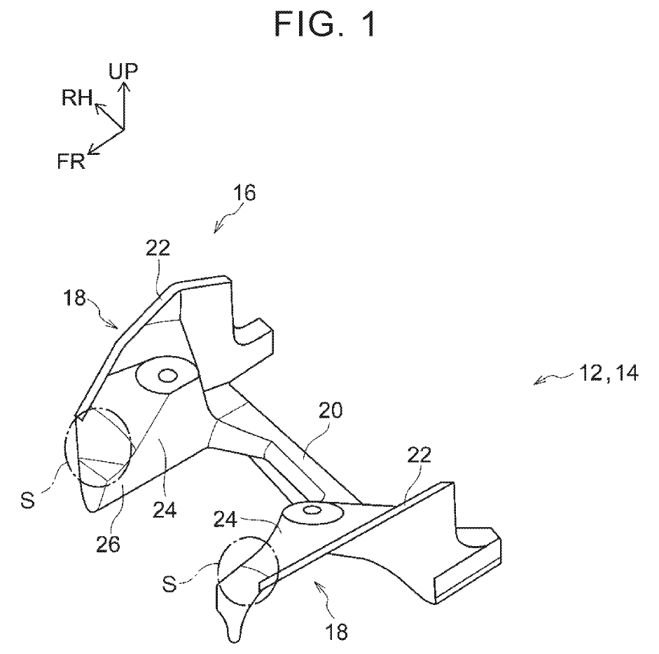

FIG. 1 shows an example of a vehicle framework member 12 to which the vehicle framework structure 10 according to the present embodiment is applied. The vehicle framework member 12 is integrally formed by casting using an aluminum alloy or the like as a material. The vehicle framework member 12 is used, for example, in a vehicle 14 such as a battery electric vehicle and a fuel cell electric vehicle that travel with power generated by a power unit.

The vehicle framework member 12 is provided with a wheel house 18 in which front wheels (not shown) are disposed on the left and right sides of the vehicle front portion 16. The right wheel house 18 and the left wheel house 18 are connected by a cross member 20. At an upper end portion of each wheel house 18, an upper member 22 extends along the vehicle front-rear direction, and a suspension tower (hereinafter referred to as a "suspension tower") 24 is provided inside the upper member 22 in the vehicle width direction. A front side member 26 extends in the vehicle front-rear direction on the downward side of the suspension tower 24.

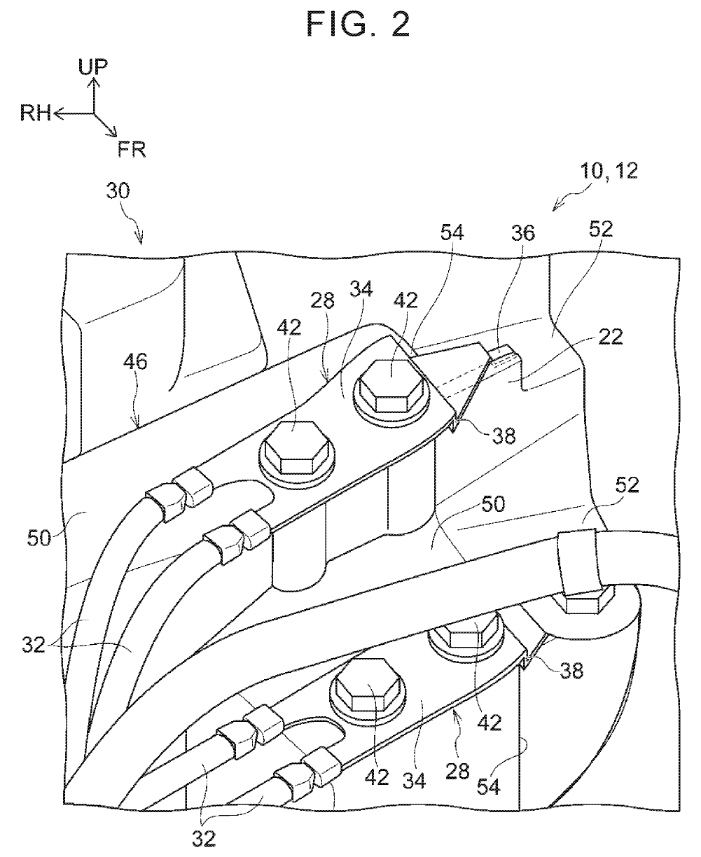

In general, a device that requires a large current, such as a cooling fan or a steering motor mounted on the vehicle 14, needs to be grounded. The negative terminal (ground terminal 28; see FIG. 2) of each device is connected to (attached to) the vehicle framework member 12.

For example, in the present embodiment, the ground terminal 28 is formed of, for example, iron, stainless steel, or the like, and is attached to an attachment portion 30 (described later) provided on the front side (S region) of the suspension tower 24 of the vehicle framework member 12. Note that the position of the attachment portion 30 is not limited to this.

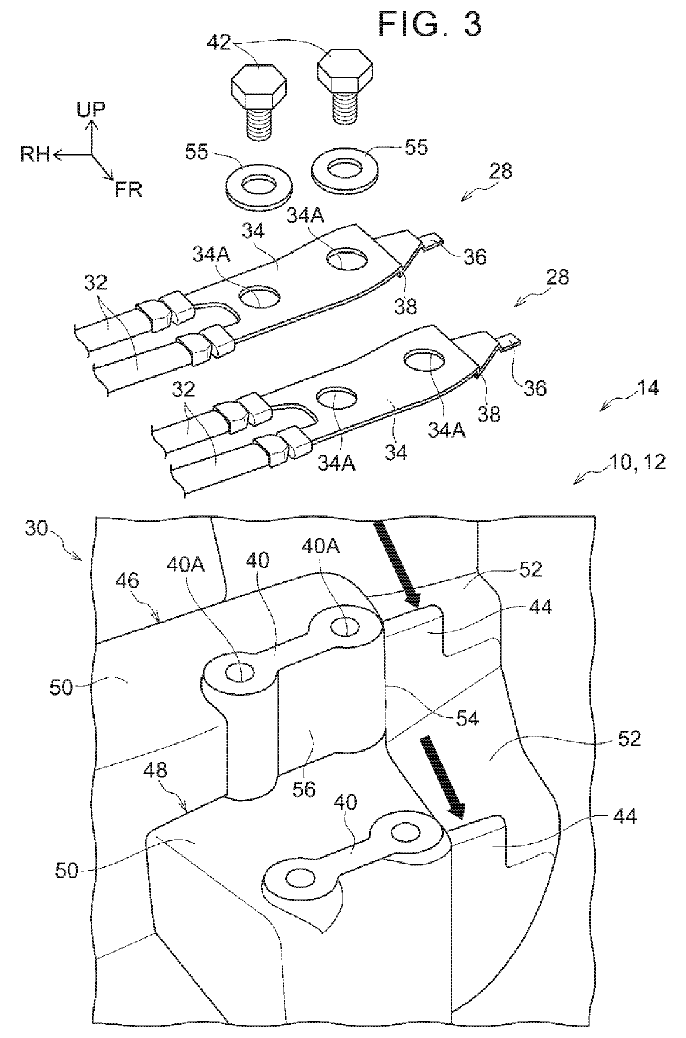

FIG. 2 is an enlarged perspective view of a main part showing a state in which the ground terminal 28 is attached to the attachment portion 30 provided in the S region on the vehicle left side of the vehicle framework member 12. FIG. 3 is an exploded perspective view illustrating a configuration of the ground terminal 28 and the attachment portion 30 provided in the vehicle framework member 12.

### Grounding terminal

First, the ground terminal 28 will be described.

The ground terminal 28 includes a conductive portion 34 to which the ground wire 32 is connected, an abutting piece (distal end portion) 36 provided on the opposite side of the ground wire 32 in the conductive portion 34, and a linking piece 38 connecting the conductive portion 34 and the abutting piece 36.

The conductive portion 34 has a flat plate shape and is capable of being in face contact with the fastening portion 40 provided in the attachment portion 30 of the vehicle framework member 12. In addition, in the conductive portion 34, a fastening hole 40A through which the fastening bolt 42 screwed into the fastening hole 40A formed in the fastening portion 40 can be inserted is formed in accordance with the fastening hole 34A.

The abutting piece 36 can be brought into contact with the rib 44 provided in the attachment portion 30. Further, the abutting piece 36 is formed on a face different from the conductive portion 34, and the abutting piece 36 and the conductive portion 34 are provided with a height difference. Therefore, the linking piece 38 connects the abutting piece 36 and the conductive portion 34 in the height direction.

Here, the linking piece 38 has a crank shape when viewed from the front side of the vehicle, and connects the abutting piece 36 and the conductive portion 34 in the height direction and the length direction (length along the longitudinal direction of the conductive portion 34). However, since the linking piece 38 only needs to connect the abutting piece 36 and the conductive portion 34 in the height direction, the shape of the linking piece 38 is not particularly limited.

### Mounting part

Next, the attachment portion 30 will be described. Note that the direction of the attachment portion 30 (the vehicle front-rear direction or the vehicle width direction) is not particularly limited and can be changed as appropriate, but for convenience of explanation, the direction shown in FIG. 2 will be described as an example.

The attachment portion 30 includes a first mounting seat 46 and a second mounting seat 48, and the second mounting seat 48 is disposed on the vehicle downward side of the first mounting seat 46. Since the basic configuration of the first mounting seat 46 and the second mounting seat 48 is substantially the same, the description of the first mounting seat 46 will be given on behalf of both, and the description of the configuration of the second mounting seat 48 will be omitted using the same reference numerals as the first mounting seat 46.

In the present embodiment, for example, the first mounting seat 46 has a rectangular shape whose longitudinal direction is the vehicle width direction in a substantially plan view. The first mounting seat 46 includes a first face 50 and a second face 52, which are the upper faces of the first mounting seat 46, and the second face 52 is disposed on the vehicle downward side of the first face 50.

Therefore, an erect face 54 connecting the first face 50 and the second face 52 is formed in the vehicle vertical direction (height direction). The height of the erect face 54 is higher than the length of the linking piece 38 of the ground terminal 28.

Here, a fastening portion 40 is formed on the first face 50 of the first mounting seat 46. The fastening portion 40 is slightly higher than the one face of the first face 50, and can be touched even though it is formed at a part that is not visible. Two fastening holes 40A are formed in the fastening portion 40, and the fastening bolts 42 can be screwed to each other via the washers 55.

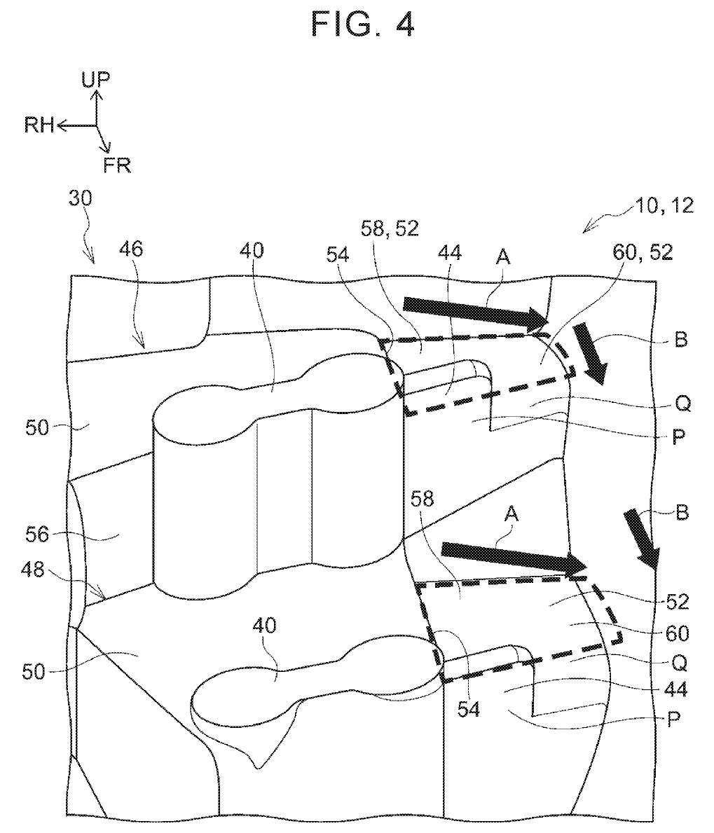

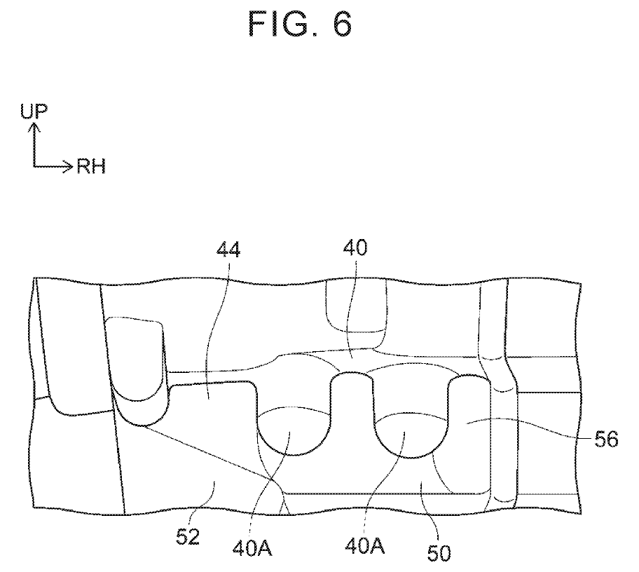

FIG. 6 shows a view of FIG. 4 from the rear side of the vehicle. As shown in FIG. 6, the fastening portion 40 has an outer shape along the shape of the fastening hole 40A when viewed from the rear side of the vehicle. That is, the first mounting seat 46 is formed in a shape in which the wall is cut out and the wall is not formed.

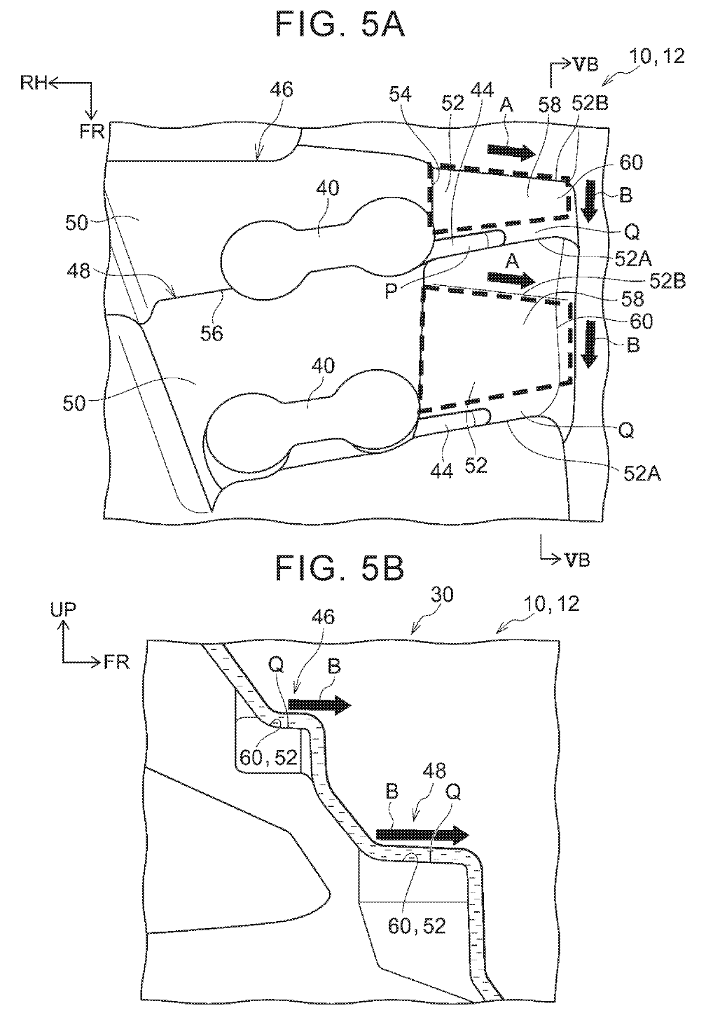

As shown in FIGS. 4 and 5A, the fastening portion 40 is provided on the second mounting seat 48 of the first face 50. The side wall 56 connecting the first mounting seat 46 and the second mounting seat 48 in the height direction is partially protruded in an arc shape along the shape of the fastening hole 40A. In FIGS. 4 and 5A, the fastening portion 40 does not include the fastening hole 40A.

On the other hand, the second face 52 is connected to the erect face 54, and the rib 44 is erected on the first outer edge portion 52A of the second mounting seat 48 on the second face 52. That is, the rib 44 is provided on the extended line of the fastening portion 40 and partially surrounds the second face 52, and the upper end of the rib 44 is formed to be slightly lower than the fastening portion 40. The rib 44 is formed to the middle of the first outer edge portion 52A of the second face 52, and the first outer edge portion 52A of the second face 52 is divided into a first portion P in which the rib 44 is formed and a second portion Q in which the rib 44 is not formed.

Further, the second face 52 is formed with a first inclined face 58 inclined toward the vehicle downward side (arrow A) in a direction away from the erect face 54. Further, on the second face 52, a second inclined face 60 is formed on the downstream side (the second portion Q side) of the first inclined face 58 in the inclination direction, which inclines toward the vehicle downward side toward the first outer edge portion 52A side from the second outer edge portion 52B provided on the opposite side of the first outer edge portion 52A (arrow B). That is, in the present embodiment, the rib 44 is formed on the upstream side of the first inclined face 58 in the inclination direction, and the second inclined face 60 is formed on the downstream side of the first inclined face 58 in the inclination direction.

### Operation and Effect of Vehicle framework Structure

Next, the operation and effects of the vehicle framework structure according to the present embodiment will be described.

In the present embodiment, the vehicle framework member 12 shown in FIG. 1 is integrally molded by casting. As shown in FIG. 3, the vehicle framework member 12 includes a first face 50, a second face 52, a erect face 54, and a rib 44 in the attachment portion 30 to which the ground terminal 28 is connected. The first face 50 has a fastening portion 40 to which the ground terminal 28 is attached, and the second face 52 is formed to be lower in height than the first face 50.

On the other hand, the rib 44 is connected to the erect face 54 and partially surrounds the second face 52 on the first outer edge portion 52A of the second face 52 on the second mounting seat 48 side, and the abutting piece 36 of the ground terminal 28 abuts. Therefore, when the ground terminal 28 is attached to the fastening portion 40, the abutting piece 36 of the ground terminal 28 abuts against the rib 44 with respect to the rotation direction of the fastening bolt 42, so that the ground terminal 28 is suppressed from rotating.

Here, as shown in FIG. 4, the second face 52 is a first inclined face 58 inclined toward the vehicle downward side (arrow A) in a direction away from the erect face 54. Therefore, the water guided on the second face 52 is guided along the first inclined face 58 toward the vehicle downward side.

As described above, in the present embodiment, in the second face 52, it is possible to provide a path through which the water immersed in the water is discharged on the second face 52 so that the water does not accumulate on the second face 52. That is, in the present embodiment, even though the rib 44 for suppressing the ground terminal 28 from rotating is provided on the second face 52, it is possible to suppress the accumulation of water around the rib 44.

Therefore, in the present embodiment, it is possible to suppress the accumulation of water in the vicinity of the ground terminal 28, it is possible to suppress the corrosion of the ground terminal 28, it is possible to suppress the leakage.

On the other hand, in the present embodiment, the second face 52 is connected to the erect face 54 and includes the first outer edge portion 52A and the second outer edge portion 52B that face each other, and the ribs 44 are erected on the first outer edge portion 52A side. In the present embodiment, the second inclined face 60 is further formed on the downstream side (the second portion Q side) of the first inclined face 58 in the inclination direction, and is inclined toward the vehicle downward side from the second outer edge portion 52B toward the first outer edge portion 52A side (arrow B).

As described above, in the present embodiment, the first inclined face 58 and the second inclined face 60 are formed on the second face 52. As a result, the water guided on the second face 52 is guided (discharged) toward the vehicle downward side along the first inclined face 58 and the second inclined face 60. Therefore, in the present embodiment, it is possible to suppress water from being accumulated on the second face 52.

Here, in the present embodiment, the ribs 44 are provided on the erect face 54 in the first outer edge portion 52A. That is, in the present embodiment, the ribs 44 are not provided on the first outer edge portion 52A opposite to the erect face 54. Therefore, the first outer edge portion 52A includes the first portion P in which the rib 44 is formed and the second portion Q in which the rib 44 is not formed.

Therefore, in the present embodiment, as shown in the drawing 5A and the drawing 5B, the water on the second face 52 is discharged to the second mounting seat 48 through the second portion Q where the ribs 44 are not formed. Since the second mounting seat 48 has substantially the same configuration as the first mounting seat 46, as a result, the water on the second face 52 of the first mounting seat 46 is discharged to the vehicle downward side via the second face 52 of the second mounting seat 48. Incidentally, the drawing 5B is a cross section when cut along VB-VB line shown in the drawing 5A, a view mainly showing the water flowing from the first mounting seat 46 to the second mounting seat 48.

Further, in the present embodiment, the height of the erect face 54 connecting the first face 50 and the second face 52 is higher than the length of the linking piece 38 provided in the ground terminal 28. Thus, in the present embodiment, when the conductive portion 34 of the ground terminal 28 is fastened to the fastening portion 40, a gap is provided between the abutting piece 36 and the second face 52 in a state in which the abutting piece 36 of the ground terminal 28 is in contact with the rib 44. Therefore, even if water adheres around the rib, it is possible to suppress the abutting piece 36 from contacting the water.

Further, when fastening the conductive portion 34 of the ground terminal 28 to the fastening portion 40, the linking piece 38 of the ground terminal 28 is in contact with the erect face 54, the abutting piece 36 of the ground terminal 28 is brought into contact with the rib 44, even though the fastening portion 40 is formed at a position not visible, it is possible to position the ground terminal 28 in three directions with respect to the first mounting seat 46. In other words, it is possible to fasten the ground terminal 28 to a predetermined position even at a position that is difficult to be visually observed.

Further, in the present embodiment, a fastening hole 40A in which the fastening bolt 42 can be screwed is formed on the first face 50 of the first mounting seat 46. Therefore, in the present embodiment, the first face 50 can be formed in a substantially flat shape. In the present embodiment, since the attachment portion 30 to which the ground terminal 28 is connected is formed in the vehicle framework member 12 molded by casting, the degree of freedom in design is improved in the shape of the attachment portion 30.

Further, as a comparative example, for example, although not shown, it is also possible to erect the boss fastening bolt 42 can be screwed to the first face 50, in this case, the shape of the first face 50 becomes complicated. Therefore, in the comparative example, there is a concern that the wall thickness of the mold is reduced in the peripheral portion of the boss, or that the gas accumulates at the time of molding at the portion where the boss is formed and the flow of hot water is deteriorated.

On the other hand, in the present embodiment, since the first face 50 is formed in a substantially flat shape, the life of the mold can be longer than in the comparative example, and the hot water flow at the time of molding is improved and the moldability is improved.

In the present embodiment, in the second face 52, the second inclined face 60 is formed on the downstream side (the second portion Q side) of the first inclined face 58 in the inclination direction, and is inclined toward the vehicle downward side (arrow B) from the second outer edge portion 52B toward the first outer edge portion 52A side. However, in the present embodiment, the second inclined face 60 is not necessarily required because it is only necessary to drain the second face 52.

Further, the first inclined face 58 and the second inclined face 60 do not necessarily have to be formed at the same angle. For example, the first inclined face 58 may be formed so as to have a larger inclination angle so that water can be drained quickly around the rib 44.

Although the second face 52 has been described in the present embodiment, the first face 50 may have an inclined face that inclines toward the vehicle downward side toward the direction away from the second face 52, similarly to the second face 52.

Further, in the above embodiment, the vehicle framework member 12 provided in the vehicle front portion has been described as the vehicle framework structure integrally molded by casting, but it is needless to say that it may be applied to the vehicle framework member provided in the vehicle rear portion.

Although an embodiment of the present disclosure has been described above, the present disclosure is not limited to such an embodiment. It is needless to say that one embodiment and various modifications may be appropriately combined and used, or the embodiments may be implemented in various forms without departing from the gist of the present disclosure.

What is claimed is:

1. A vehicle framework structure comprising a vehicle framework member that is integrally molded by casting,
the vehicle framework member including
a first face including a fastening portion to which a ground terminal is attached,
a second face of which a height is lower than that of the first face,
an erect face connecting the fastening portion and the second face in a height direction, and
a rib connected to the erect face and partially surrounding the second face, the rib being abutted by a distal end portion of the ground terminal, wherein
the second face is a first inclined face that inclines toward a vehicle downward side in a direction away from the erect face.

2. The vehicle framework structure according to claim 1, wherein
the second face is configured including
a first outer edge portion connected to the erect face, and on which the rib is erected and
a second outer edge portion that is connected to the erect face and that faces the first outer edge portion, and
the first inclined face further includes a second inclined face inclined toward the vehicle downward side from a second outer edge portion side toward a first outer edge portion side.

3. The vehicle framework structure according to claim 2, wherein the rib is fashioned on an upstream side in an inclination direction of the first inclined face, and the second inclined face is fashioned on a downstream side in the inclination direction of the first inclined face.

4. The vehicle framework structure according to claim 1, wherein
the ground terminal is configured including
a conductive portion fastened to the fastening portion,
a distal end portion fashioned on a face that is different from the conductive portion and that is configured to abut the rib, and
a linking piece connecting between the conductive portion and the distal end portion in the height direction, and
a height of the erect face is higher than a length of the linking piece.
